(19) United States
(12) Patent Application Publication
(10) Pub. No.: US 2017/0048436 A1
(43) Pub. Date: Feb. 16, 2017

(54) Viewing Angle Switching Method and Camera Therefor

(71) Applicant: VIVOTEK INC., New Taipei City (TW)

(72) Inventor: Szu-Han Chen, New Taipei City (TW)

(21) Appl. No.: 15/213,362

(22) Filed: Jul. 18, 2016

(30) Foreign Application Priority Data
Aug. 11, 2015 (TW) 104126067

(51) Int. Cl. H04N 5/232; G06T 3/60; G06T 3/40; G06T 11/60

(52) U.S. Cl. CPC H04N 5/232; G06T 11/60; G06T 3/60; G06T 3/40; G06T 2207/20021

(57) ABSTRACT

A viewing angle switching method capable of conveniently adjusting region of interest (ROI) and user-friendly displaying image can be applied to a related camera. The viewing angle switching method includes setting at least one first region of interest and one second region of interest within a monitoring image, displaying the first region of interest on a monitoring screen, analyzing direction information of a switching command, and determining whether to rotate the second region of interest by a predetermined angle and to display the rotated second region of interest in accordance with the direction information.

### BACKGROUND OF THE INVENTION

1. Field of the Invention

The present invention relates to a viewing angle switching method and a related camera, and more particularly, to a viewing angle switching method and a related camera capable of conveniently adjusting the region of interest within an image.

2. Description of the Prior Art

The conventional fisheye monitoring apparatus is disposed on the ceiling, the wall or the floor. A fisheye lens of the monitoring apparatus is utilized to capture a panorama image containing all characteristic information inside the monitoring area. However, a vision field of the fisheye lens is approximate to 180 degrees wide, a central region of the fisheye image is clear for observation, but a side region of the fisheye image is uncomfortable to identify detailed characteristics. The user has to swing the head around to match with the side region of the fisheye image. Further, the conventional fisheye monitoring apparatus with high quality cannot deliver the video smoothly because of low frame rate.

### SUMMARY OF THE INVENTION

The present invention provides a viewing angle switching method and a related camera capable of conveniently adjusting the region of interest within an image for solving above drawbacks.

In accordance with the claimed invention, a viewing angle switching method capable of conveniently adjusting a region of interest includes setting a first region of interest and a second region of interest within a monitoring image, displaying the first region of interest on a monitoring screen, analyzing direction information of a switching command, and determining whether to rotate the second region of interest by a predetermined angle and display the rotated second region of interest in accordance with the direction information.

In accordance with the claimed invention, a camera capable of conveniently adjusting a region of interest includes an image capturing unit adapted to capture a monitoring image, and a processing controller electrically connected to the image capturing unit. The processing controller is adapted to set a first region of interest and a second region of interest within the monitoring image, to display the first region of interest on a monitoring screen, to analyze direction information of a switching command, and to determine whether to rotate the second region of interest by a predetermined angle and display the rotated second region of interest in accordance with the direction information.

The viewing angle switching method of the present invention removes parts of the original capturing image I1 to form the rectangular monitoring image I2 for increasing frame rate of the camera 10. The monitoring image I2 is elongated, the viewing angle switching method can divide the monitoring image I2 into several regions of interest R1, R2, R3 partly overlapped with each other, and the monitoring screen 16 may display one of the regions of interest alone, display several regions of interest arranged side by side, or display the regions of interest adjacent to the monitoring image I2. While the monitoring screen 16 is utilized to mainly display the specific region of interest (such as the first region of interest R1), the viewing angle switching method can determine whether to switch those regions of interest according to the direction information and quantity of the switching command, and further determine which one from the regions of interest is selected and displayed, so as to provide comfortable observation by rotating the region of interest in compliance with human practical tendency. Further, the viewing angle switching method can shrink or enlarge the predefined region from the region of interest according to utilization demand for observing detailed characteristic of the fisheye panorama image. The viewing angle switching method and the related camera of the present invention provides diverse and humanistic image showing selection, and the user can arbitrarily display and switch the specific region of interest within the monitoring image on the monitoring screen.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a camera according to an embodiment of the present invention.

FIG. 2 and FIG. 3 respectively are diagrams of images captured by the camera in different operation modes according to the embodiment of the present invention.

FIG. 4 is a flow chart of a viewing angle switching method according to the embodiment of the present invention.

FIG. 5 is a diagram of a monitoring image and the regions of interest arranged side by side according to the embodiment of the present invention.

FIG. 6 is a diagram of a monitoring screen according to the embodiment of the present invention.

FIG. 7 and FIG. 8 respectively are diagrams of the regions of interest in different operation according to the embodiment of the present invention.

### DETAILED DESCRIPTION

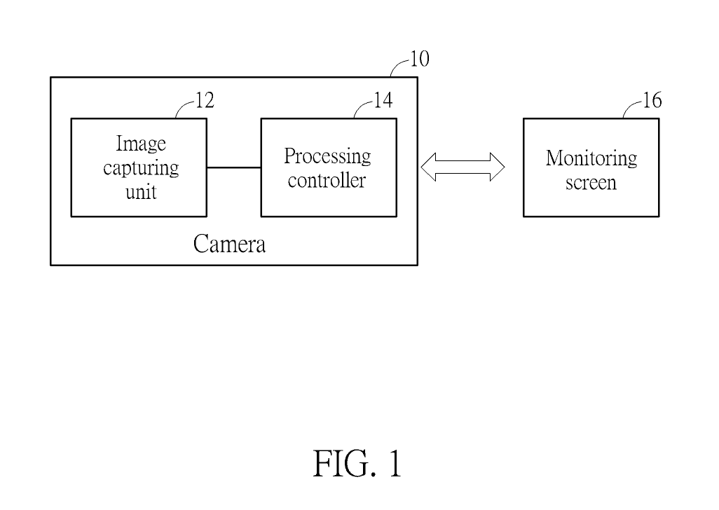

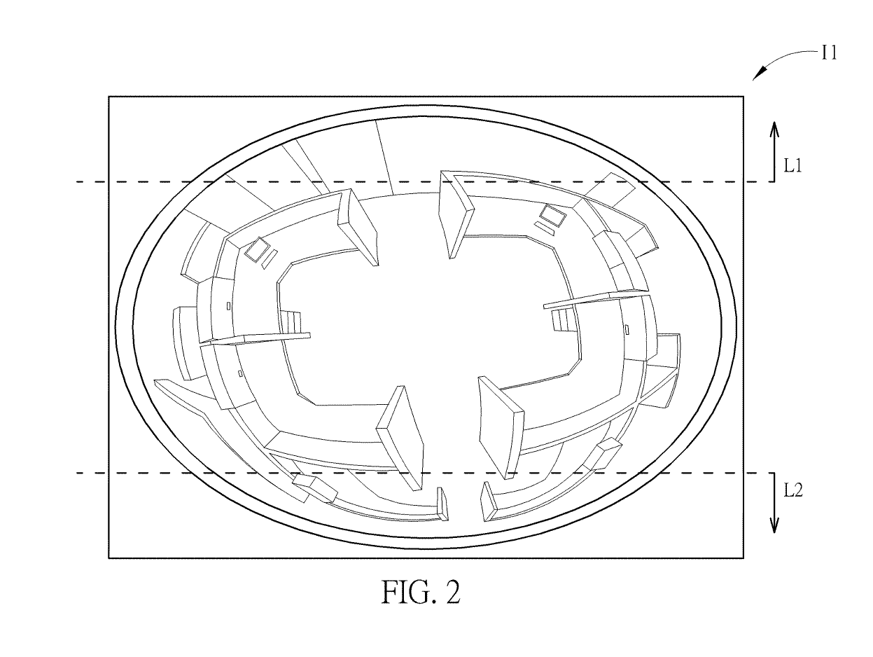

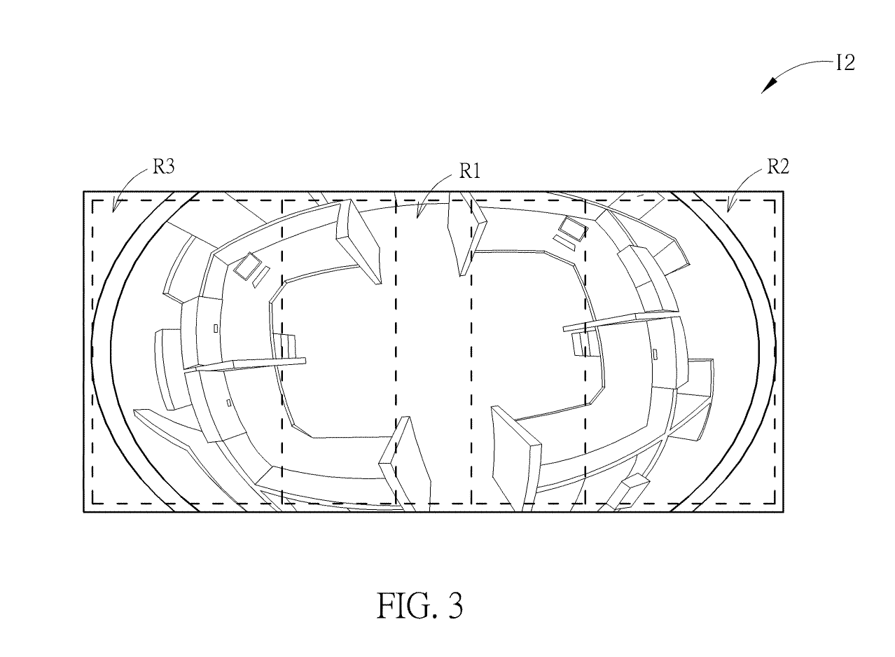

Please refer to FIG. 1 to FIG. 3. FIG. 1 is a functional block diagram of a camera 10 according to an embodiment of the present invention. FIG. 2 and FIG. 3 respectively are diagrams of images captured by the camera 10 in different operation modes according to the embodiment of the present invention. The camera 10 includes an image capturing unit 12 and a processing controller 14 electrically connected with each other. The image capturing unit 12 is adapted to capture the image, and the processing controller 14 transforms the image into a conformed format by image processing procedure. The camera 10 of the present invention can conveniently adjust position of a region of interest (ROI) within the captured image. Generally, the camera 10 sets the region of interest having a specific shape (such as the rectangular form) within the captured image. The rectangular region of interest not only generates the rectangular view range matched with the monitoring screen 16, but also provides preferred FPS (frames per second) for smooth video delivering.

The camera 10 of the present invention preferably can be a fisheye monitor disposed on the floor or the ceiling inside monitor environment. The camera 10 acquires an original capturing image I1 in the beginning, such like the fisheye panorama image I1 shown in FIG. 2, and removes a part of the original capturing image I1 to form a monitoring image I2, such like the rectangular image I2 shown in FIG. 3. The camera 10 sets the region of interest within the monitoring image I2, the monitoring screen 16 may merely display the region of interest for detailed observation, or simultaneously display the monitoring image I2 and the region of interest for comparative observation. Because dimensions of the region of interest is smaller than dimensions of the monitoring image I2, the camera 10 may freely adjust position of the region of interest within the monitoring image I2 according to a switching command input by the user, to avoid missing accidental situation in the monitor environment.

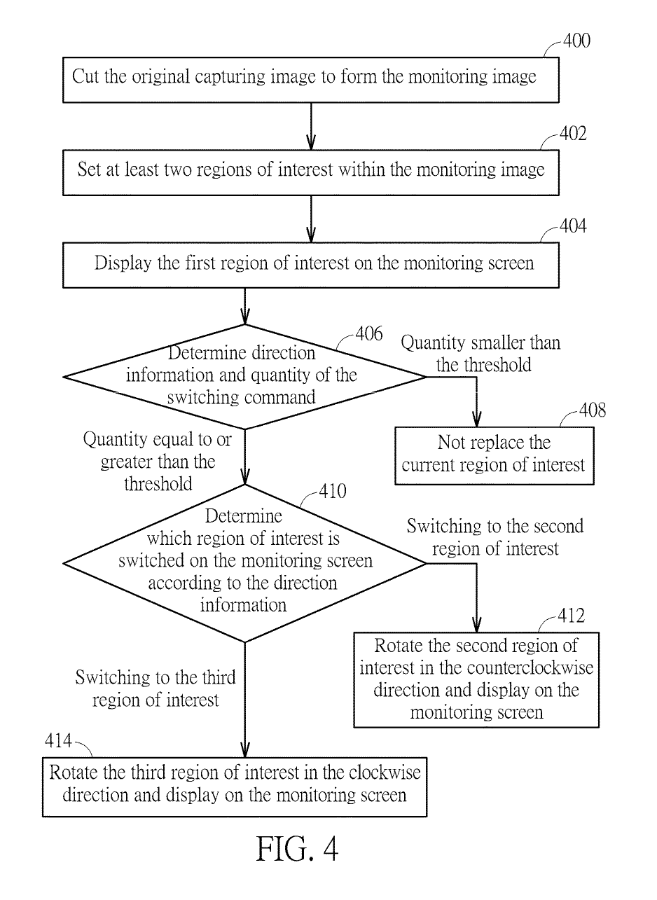

Please refer to FIG. 4. FIG. 4 is a flow chart of a viewing angle switching method according to the embodiment of the present invention. The viewing angle switching method illustrated in FIG. 4 is suitable for the camera 10 shown in FIG. 1 and is used to conveniently adjust position of the region of interest within the captured image, so that the user can observe the region of interest by comfortable posture accordingly. First, step 400 is executed that the processing controller 14 acquires and cuts the original capturing image I1 (which is captured by the image capturing unit 12) to form the monitoring image I2. For example, a rectangular region with specific dimensions (such like a first rectangular region with a first specific dimensions) may be removed from a top of the original capturing image I1, and another rectangular region with individual specific dimensions (such like a second rectangular region with a second specific dimensions) may be removed from a bottom of the original capturing image I1, which means parts of the original capturing image I1 above the line L1 and below the line L2 shown in FIG. 2 are taken away. Location of the lines L1 and L2 are not limited to the above-mentioned embodiment, distance of the lines L1 and L2 relative to edges of the original capturing image I1 can be different or equivalent to each other, which depend on design demand.

Then, step 402 is executed that the processing controller 14 sets at least two regions of interest within the monitoring image I2, such as the first region of interest R1 and the second region of interest R2 shown in FIG. 3; additionally, the third region of interest R3 or more regions of interest may be available in accordance with actual demand. In this embodiment, the first region of interest R1 is located on a middle of the monitoring image I2, the second region of interest R2 is located on a right side of the monitoring image I2, and the third region of interest R3 is located on a left side of the monitoring image I2. The regions of interest can be, but not limited to, partly overlapped with each other. Later, step 404 is executed to display the first region of interest R1 on the monitoring screen 16 for an initial frame. While the camera 10 receives the switching command input by the user, step 406 is executed to analyze direction information and quantity of the switching command. Step 408 is executed to keep the current region of interest since the foresaid quantity is smaller than a threshold, touch of the switching command is represented as an accident or a noise, so the region of interest displayed on the monitoring screen 16 is unchangeable. Step 410 is executed to display the following region of interest since the foresaid quantity is equal to or greater than the threshold, and one of the second region of interest R2 and the third region of interest R3 is selected to display on the monitoring screen 16 in accordance with the direction information.

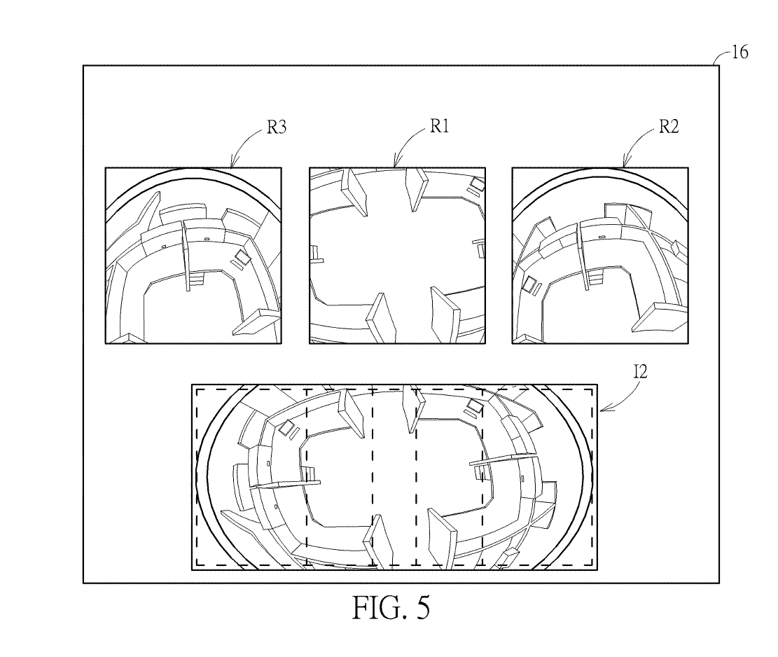

The user can input the direction information via any input device, such as the mouse or the touch screen. As the direction information is oriented toward right (such like dragging the mouse to left; however the mouse may be dragged to the right by specific demand), the second region of interest R2 is purposed to display on the monitoring screen 16, step 412 is executed that the processing controller 14 rotates the second region of interest R2 to a predetermined angle at a counterclockwise direction and then displays the rotated second region of interest R2 on the monitoring screen 16. As the direction information is oriented toward the left (such like dragging the mouse to the right; however the mouse may be dragged to the left by the specific demand), the third region of interest R3 is purposed to display on the monitoring screen 16, step 414 is executed that the processing controller 14 rotates the third region of interest R3 to the predetermined angle at a clockwise direction and then displays the rotated third region of interest R3 on the monitoring screen 16. Rotary directions of the second region of interest R2 and the third region of interest R3 are designed according to location of the side region of interest relative to the middle region of interest, which are not limited to the above-mentioned embodiment. Generally, the predetermined angle can be adjusted in accordance with a shape of the monitoring image I2 and/or relation between the original capturing image I1 and the monitoring image I2, and is defined as, but not limited to, ninety degrees. In steps 412 and 414, the rotated second region of interest R2 (or the rotated third region of interest R3) is used to replace the previous region of interest (such like the first region of interest R1) and can be displayed on the monitoring screen 16. Moreover, as shown in FIG. 5, the rotate second region of interest R2 and/or the rotated third region of interest R3 can be displayed on the monitoring screen 16 adjacent to the previous region of interest (such like the first region of interest R1) and/or the monitoring image I2. FIG. 5 is a diagram of the monitoring image I2 and the regions of interest arranged side by side according to the embodiment of the present invention.

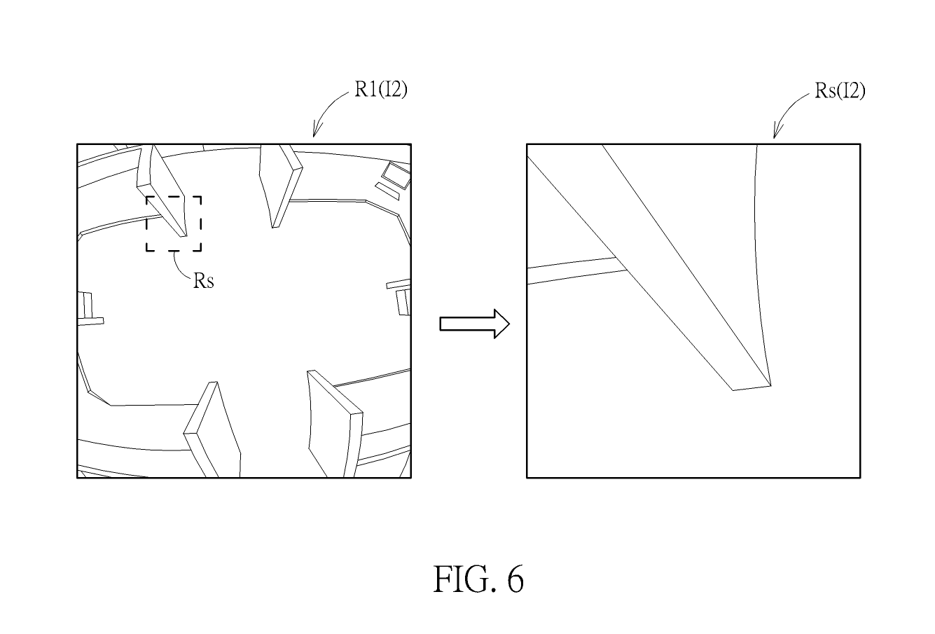

Please refer to FIG. 6. FIG. 6 is a diagram of the monitoring screen 16 according to the embodiment of the present invention. As shown in FIG. 6, the first region of interest R1 is cited as an instance that the single region of interest is displayed on the monitoring screen 16. While the user intends to observe a specific range of the first region of interest R1, the input interface (such like the mouse, the keyboard or the touch pad) is utilized to select a specific region Rs within the first region of interest R1, a scaling ratio of the specific region Rs is adjusted according to the scaling control command (such as turning number of the mouse roller, clicking parameters of the keyboard) of the input interface, and the specific region Rs can be enlarged to be identical with a size of the monitoring screen 16, so that the user can clearly identify image characteristics inside the predefined region Rs.

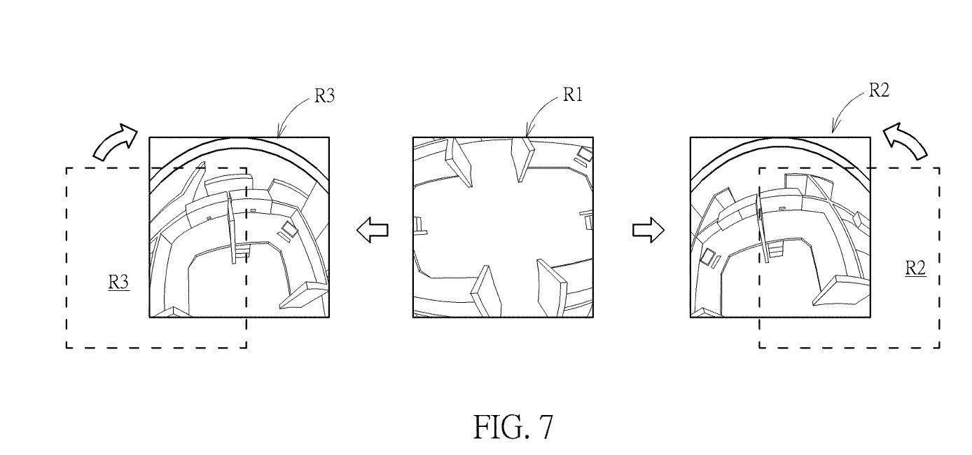

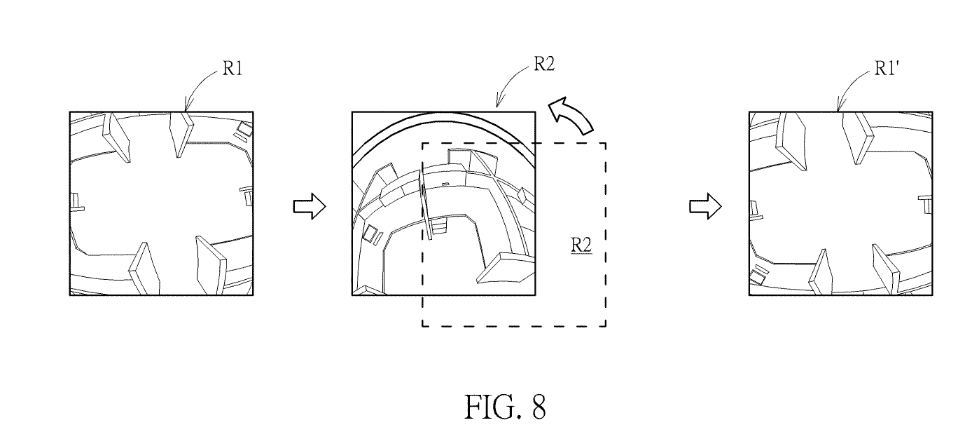

Please refer to FIG. 7 and FIG. 8. FIG. 7 and FIG. 8 respectively are diagrams of the regions of interest in different operation according to the embodiment of the present invention. In the embodiment shown in FIG. 7, the monitoring screen 16 displays the first region of interest R1 in the beginning, the second region of interest R2 is counterclockwise rotated to ninety degrees from orientation shown in FIG. 3 (which means the dotted region shown in FIG. 7) while receiving the switching command for left shift, and the rotated second region of interest R2 is displayed on the monitoring screen 16; in the event of receiving the switching command for right shift, the monitoring screen 16 is recovered to display the first region of interest R1. While the switching command for right shift is received, the third region of interest R3 is clockwise rotated to ninety degrees from orientation shown in FIG. 3 (which means the dotted region shown in FIG. 7) and then is displayed on the monitoring screen 16; in the event of receiving the switching command for left shift, the monitoring screen 16 is recovered to display the first region of interest R1.

In the embodiment shown in FIG. 8, the monitoring screen 16 displays the first region of interest R1 in the beginning. While receiving the switching command for left shift, the second region of interest R2 is counterclockwise rotated to ninety degrees from orientation shown in FIG. 3 (which means the dotted region shown in FIG. 8) and is accordingly displayed on the monitoring screen 16. Afterwards, the monitoring screen 16 can be recovered to display the initial first region of interest R1 while receiving the switching command for right shift; in the event of receiving the switching command for left shift, the monitoring screen 16 turns the first region of interest R1 upside down to generate and display the overturned first region of interest R1′. The first region of interest R1′ displayed on the monitoring screen 16 can be replaced by the second region of interest R2 or the third region of interest R3, the related flow process is mentioned as above and a detailed description is omitted herein for simplicity.

In conclusion, the viewing angle switching method of the present invention removes parts of the original capturing image I1 to form the rectangular monitoring image I2 for increasing frame rate of the camera 10. The monitoring image I2 is elongated, the viewing angle switching method can divide the monitoring image I2 into several regions of interest R1, R2, R3 partly overlapped with each other, and the monitoring screen 16 may display one of the regions of interest alone, display several regions of interest arranged side by side, or display the regions of interest adjacent to the monitoring image I2. While the monitoring screen 16 is utilized to mainly display the specific region of interest (such as the first region of interest R1), the viewing angle switching method can determine whether to switch those regions of interest according to the direction information and quantity of the switching command, and further determine which one from the regions of interest is selected and displayed, so as to provide comfortable observation by rotating the region of interest in compliance with human practical tendency. Further, the viewing angle switching method can shrink or enlarge the predefined region from the region of interest according to utilization demand for observing detailed characteristic of the fisheye panorama image. Comparing to the prior art, the viewing angle switching method and the related camera of the present invention provides diverse and humanistic image showing selection, and the user can arbitrarily display and switch the specific region of interest within the monitoring image on the monitoring screen.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A viewing angle switching method capable of conveniently adjusting a region of interest, the viewing angle switching method comprising:
setting a first region of interest and a second region of interest within a monitoring image;
displaying the first region of interest on a monitoring screen;
analyzing direction information of a switching command; and
determining whether to rotate the second region of interest by a predetermined angle and display the rotated second region of interest in accordance with the direction information.

2. The viewing angle switching method of claim 1, wherein a step of determining whether to rotate the second region of interest by the predetermined angle and display the rotated second region of interest in accordance with the direction information comprises:
rotating the second region of interest clockwise or counterclockwise to the predetermined angle in accordance with the direction information.

3. The viewing angle switching method of claim 1, wherein the first region of interest is partly overlapped with the second region of interest within the monitoring image.

4. The viewing angle switching method of claim 1, wherein the rotated second region of interest is displayed on the monitoring screen to replace the first region of interest, or is displayed on the monitoring screen adjacent to the displayed first region of interest.

5. The viewing angle switching method of claim 1, further comprising:
setting a third region of interest within the monitoring image, wherein the first region of interest is located between the second region of interest and the third region of interest; and
determining whether to rotate the third region of interest by the predetermined angle and display the rotated third region of interest in accordance with the direction information.

6. The viewing angle switching method of claim 1, further comprising:
acquiring an original capturing image; and
removing a part of the original capturing image to form the monitoring image.

7. The viewing angle switching method of claim 6, wherein the original capturing image is a fisheye panorama image, and the monitoring image is a rectangular image.

8. The viewing angle switching method of claim 6, wherein a step of removing the part of the original capturing image to form the monitoring image comprises:
removing a first rectangular region with a first specific dimensions from a top of the original capturing image; and
removing a second rectangular region with a second specific dimensions from a bottom of the original capturing image.

9. The viewing angle switching method of claim 1, further comprising:
selecting a specific region within the monitoring image; and
adjusting a scaling ratio of the specific region in accordance with a scaling command.

10. A camera capable of conveniently adjusting a region of interest, the camera comprising:
an image capturing unit adapted to capture a monitoring image; and
a processing controller electrically connected to the image capturing unit and adapted to set a first region of interest and a second region of interest within the monitoring image, to display the first region of interest on a monitoring screen, to analyze direction information of a switching command, and to determine whether to rotate the second region of interest by a predetermined angle and display the rotated second region of interest in accordance with the direction information.

11. The camera of claim 10, wherein the processing controller is further adapted to rotate the second region of interest clockwise or counterclockwise to the predetermined angle in accordance with the direction information.

12. The camera of claim 10, wherein the first region of interest is partly overlapped with the second region of interest within the monitoring image.

13. The camera of claim 10, wherein the rotated second region of interest is displayed on the monitoring screen to replace the first region of interest, or is displayed on the monitoring screen adjacent to the displayed first region of interest.

14. The camera of claim 10, wherein the processing controller is further adapted to set a third region of interest within the monitoring image, wherein the first region of interest is located between the second region of interest and the third region of interest, to determine whether to rotate the third region of interest by another predetermined angle and display the rotated third region of interest in accordance with the direction information.

15. The camera of claim 10, wherein the processing controller is further adapted to acquire an original capturing image, and to remove apart of the original capturing image to form the monitoring image.

16. The camera of claim 15, wherein the original capturing image is a fisheye panorama image, and the monitoring image is a rectangular image.

17. The camera of claim 15, wherein the processing controller is further adapted to remove a first rectangular region with a first specific dimensions from a top of the original capturing image, and to remove a second rectangular region with a second specific dimensions from a bottom of the original capturing image.

18. The camera of claim 10, wherein the processing controller is further adapted to select a specific region within the monitoring image, and to adjust a scaling ratio of the specific region in accordance with a scaling command.
